(19) United States
(12) Patent Application Publication
(10) Pub. No.: US 2023/0024112 A1
(43) Pub. Date: Jan. 26, 2023

(54) FABRIC TREATMENT

(71) Applicant: The Procter & Gamble Company, Cincinnati, OH (US)

(72) Inventors: Neil Joseph LANT, Newcastle Upon Tyne (GB); Samuel Kimani Njoroge, Montgomery, OH (US); Todd Michael Wernicke, Cincinnati, OH (US); Julie Marie Porter, Amelia, OH (US)

(21) Appl. No.: 17/829,436

(22) Filed: Jun. 1, 2022

(30) Foreign Application Priority Data
Jul. 19, 2021 (EP) 21186294.1

(51) Int. Cl. C11D 3/38; C11D 11/00; C11D 3/00; C11D 3/37; C11D 3/20; C11D 17/00

(52) U.S. Cl. CPC C11D 3/381; C11D 11/0017; C11D 3/0068; C11D 3/0036; C11D 3/3703; C11D 3/3788; C11D 3/2086; C11D 3/2079; C11D 17/0043

(57) ABSTRACT

A method of depositing bacterial spores on a moisture-wicking synthetic fabric, includes contacting the fabric with an aqueous liquor comprising at least 1×10² CFU/l of the aqueous liquor, of bacterial spores wherein the aqueous liquor is substantially free of fabric conditioning agent.

### FIELD OF THE INVENTION

The present application relates to a method of treating a fabric to provide malodor reduction and malodor prevention. The present application also relates to a composition that provides sustained malodor removal and malodor prevention.

### BACKGROUND OF THE INVENTION

Garments intended for use as athletic wear are becoming more popular, even for use during non-athletic pursuits. Such garments are often valued for their wicking properties during wear, where water and sweat are drawn away from the body so that they can more easily be evaporated. These garments, made from synthetic materials, tend to produce malodor while in use.

There is a need for compositions and processes that helps to combat malodor of fabrics with wicking properties during use.

### SUMMARY OF THE INVENTION

According to a first aspect, there is provided a method of depositing bacterial spores on a moisture-wicking synthetic fabric. The method comprises the step of contacting the fabric with an aqueous liquor. The aqueous liquor comprises least 1×10² CFU/liter, preferably from about 1×10² CFU/liter to about 1×10⁸ CFU/liter, more preferably from about 1×10⁴ CFU/liter to about 1×10⁷ CFU/liter of bacterial spores. The aqueous liquor is substantially free of fabric conditioning agent. Fabric conditioning agents can lay down a waxy residue that interferes with the moisture-wicking synthetic fabric finishing that can alter the moisture-wicking performance.

According to the second aspect, there is provided a composition comprising bacterial spores and substantially free of fabric conditioning agent. Compositions substantially free of fabric conditioning agent provide good care to moisture-wicking synthetic fabrics without altering the moisture-wicking properties. Preferably the composition is also substantially free of bleach. Compositions substantially free of bleach provide good care to moisture-wicking synthetic fabrics without altering the moisture-wicking properties. Preferably, the composition comprises less than 5%, more preferably less than 2% by weight of the composition of surfactant. Preferably the composition comprises less than 2%, preferably less than 1% by weight of the composition of anionic surfactant. Preferably the composition comprises less than 2%, preferably less than 1% by weight of the composition of cationic surfactant. Compositions with low level of surfactant or substantially free of surfactant, in particular anionic surfactant and cationic surfactant, provide good care to moisture-wicking synthetic fabrics without altering the moisture-wicking properties.

According to the third aspect, there is provided the use of a composition to provide sustained malodor removal and/or prevention from fabrics over a long period of time.

According to an additional aspect, there is provided a moisture-wicking synthetic fabric comprising at least 1×10² CFU per gram of fabric of bacterial spores, preferably from 1×10⁴ to 1×10⁶ CFU per gram of fabric of bacterial spores.

The elements of the method of the invention described in relation to the first aspect apply mutatis mutandis to the other aspects.

### DETAILED DESCRIPTION OF THE INVENTION

The present application encompasses a method of depositing bacterial spores on a moisture-wicking synthetic fabric. The method comprises the step of contacting the fabric with an aqueous liquor comprising at least 1×10² CFU/liter, preferably from about 1×10² CFU/liter to about 1×10⁸ CFU/liter, more preferably from about 1×10⁴ CFU/liter to about 1×10⁷ CFU/liter of bacterial spores, preferably Bacillus spores. The aqueous liquor is substantially free of fabric conditioning agent.

The present application also encompasses a composition suitable for depositing bacterial spores on a moisture-wicking synthetic fabric. A method and composition provide spore deposition on a fabric that in turns provide malodor removal and prevention during a sustained period of time. Without being bound by theory, it is believed that the moisture and heat from sweat can help germination of spores. The substances contained in sweat may also act as nutrients for the bacteria.

The present application also encompasses the use of the method and the composition of the invention to provide bacterial spore deposition on a moisture-wicking synthetic fabric that in turn provide sustained malodor removal and malodor prevention from the fabric. By “sustained malodor removal” is meant that the malodor removal and/or prevention takes place for at least 24 hours, preferably for at least 48 hours after the fabric has been treated. Without being bound by theory it is believed that the bacterial spores germinate with the heat and moisture from sweat from the user, thereby producing malodor removal and prevention during the wearing of the fabric.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

By “substantially free aqueous liquor” is meant that the aqueous liquor comprises less than 100 ppm of the specific compound.

By “substantially free composition” is meant that the composition comprises less than 1%, preferably less than 0.5% and especially 0 of the specific compound.

Method of Treating a Moisture-Wicking Synthetic Fabric

The present disclosure relates to a method of treating a moisture-wicking synthetic fabric to deposit bacterial spores on the fabric, preferably the bacterial spores comprise Bacillus spores.

The method of the present disclosure includes contacting a fabric with an aqueous treatment liquor. The aqueous liquor comprises at least 1×10² CFU/l of the aqueous liquor, preferably from about 1×10² to about 1×10⁸ CFU/l of the aqueous liquor of bacterial spores, preferably Bacillus spores.

The method of treating a fabric may take place in any suitable vessel, in its entirety or partially, for example it may take place in an automatic washing machine. Such machines may be top-loading machines or front-loading machines. The whole process can take place in a washing machine. The process of the invention is also suitable for hand washing applications.

The treatment step may be part of a wash or a rinse cycle of an automatic washing machine. The aqueous treatment liquor may be an aqueous rinse liquor. A composition according to the present disclosure may be added to the drawer or drum of an automatic washing machine during a wash or a rinse cycle.

The treatment step of the method of the present disclosure may include contacting the fabric with an aqueous wash liquor. The step of contacting the fabric with an aqueous wash liquor may occur prior to contacting the fabric with an aqueous rinse liquor. Such steps may occur during a single treatment cycle. The aqueous wash liquor may comprise a cleaning composition, such as a granular or liquid laundry detergent composition, that is dissolved or diluted in water. The detergent composition may include anionic surfactant. The aqueous wash liquor may comprise from about 50 to about 5000 ppm, or from about 100 to about 1000 ppm, anionic surfactant.

The method of invention can comprise a laundry process comprising a wash and a rinse cycle and wherein the bacterial spores can be delivered to the fabric from a cleaning composition and/or from an additive composition. The bacterial spores may be delivered into the wash cycle, the rinse cycle or the drying cycle, preferably into the rinse cycle.

Alternative, the aqueous liquor can be delivered to the fabric from a product in the form of a spray.

### Fabric

The fabric treated by the method of the invention comprises at least some synthetic fiber, i.e. fibers that are not of natural origin (e.g. cotton, flax, jute, hemp, ramie, silk, wool, mohair, cashmere) or regenerated from a cellulosic feedstock (e.g. viscose/Lyocell/rayon and related regenerated celluloses, acetate, triacetate). Examples of suitable synthetic fibers include polyester, acrylic, elastane (Spandex, Lycra), polyamide (Nylon), polyethylene, polypropylene, polyurethane. The fiber composition of a textile is typically declared by the manufacturer, but it can also be determined experimentally using test methods familiar to those skilled in the art, such as ASTM D629-15: Standard Test Methods for Quantitative Analysis of Textiles, ASTM International, West Conshohocken, Pa.; 2015.

By “synthetic fabric” is herein meant a fabric that comprises more than 70% by weight of the fabric of synthetic fiber, preferably more than 80%, preferably more than 95%, preferably more than 98%, preferably about 100% by weight of the fabric of synthetic fiber.

Preferably, the fabric comprises more than 70% by weight of the fabric of polyester, preferably at least 80%, preferably at least 90% and even more preferably at least 95%, and even more preferably at least 98% by weight of the fabric of polyester. The non-synthetic fiber content of the textile may comprise natural or regenerated fibers as listed above. The fabric may optionally comprise elastane.

By “moisture-wicking fabric” is herein meant a fabric that has a wicking distance of at least 3 cm, more preferably at least 5 cm, as measured with water in 15 minutes, as specified in Test Method 1.

The moisture-wicking synthetic fabric of the present invention preferably has the following properties:

(i) comprises at least 95%, more preferably at least 98%, most preferably 100% synthetic fiber. The synthetic fiber preferably comprise one or more of polyester, polyamide (Nylon), elastane (a polyester-polyurethane co-polymer also known as Spandex or Lycra), acrylic, polyurethane, polyvinyl chloride (PVC); and

(ii) exhibits a wicking distance of at least 3 cm, more preferably at least 5 cm as measured using Test Method 1.

The fabric has an inner surface intended to be in contact with the skin of the wearer and an outer surface opposite to the inner surface. The fabric is preferably made of yarns, more preferably the fabric comprises polyester yarns. Preferably, the yarns have a linear density of from about 30 to 140 denier, more preferably from about 50 to 90 denier.

Warp knitting is a family of knitting methods in which the yarn zigzags along the length of the fabric; i.e., following adjacent columns, or wales, of knitting, rather than a single row, or course.

While synthetic fabrics have long been associated with formation and retention of malodors (known as ‘permastink’), the method and composition of the invention provide very good malodor removal and/or malodor prevention on synthetic fabric.

Fabrics made from synthetic materials do not readily absorb moisture, due to being hydrophobic. As a result, when untreated synthetic fabrics are worn under conditions of even moderate perspiration, moisture tends to build up on the skin, because the fabric does not absorb moisture. Thus, when wearing untreated garments made of synthetic fibers, water tends to bead up and become trapped on the inner surface of the garment, resulting in an extremely uncomfortable garment.

A variety of methods have been used to improve the wicking characteristics of untreated synthetic textiles. One common method is to apply a hydrophilic finish to a hydrophobic fabric made from synthetic fibers, rendering it a moisture-wicking fabric. A second method of improving moisture transfer is to use various fabric construction techniques to create fabrics that are more hydrophobic on one surface and more hydrophilic on the other surface, leading to moisture transfer from the hydrophobic side to the hydrophilic side.

In the first method, as mentioned above, a hydrophilic finish is applied durably to a synthetic fiber fabric. For example, see U.S. Pat. Nos. 6,855,772 and 6,544,594. These fabrics quickly transfer and spread moisture, increasing the surface area of the moisture to enhance evaporation. Since the underlying fibers are hydrophobic, the fibers themselves do not absorb moisture, unlike cotton or wool fibers. Because these fabrics do not absorb moisture into the fibers themselves, the moisture resides primarily in the capillaries between fibers and yarns. This enhances lateral wicking, which may lead to a greater surface area of the moisture and thus faster drying. However, the moisture still resides throughout the thickness of the fabric. This means that the inner surface (touching the skin) can remain wet and clingy. In addition, when compared to natural fiber fabrics, synthetic fiber fabrics are generally known to have other undesirable properties, such as pilling, static cling, odor retention, and an “unnatural” feel. This type of hydrophilic-treatment is designed primarily for synthetic fabrics.

In the second method, various kinds of fabric construction techniques have also been used to create fabrics that transfer moisture form one side of the fabric to the other. One such fabric construction is described in U.S. Patent Publication No. 2003/0181118, which describes generally a fabric made from two different types of yarn, where one yarn is more hydrophilic and the other is more hydrophobic. These yarns are woven or knitted in such a way that the hydrophobic yarns are predominantly on one side of the fabric and the hydrophilic yarns are primarily on the other side of the fabric. A portion of the hydrophilic yarns penetrates to the hydrophobic side, acting to channel liquid to the hydrophilic side. As a result, water is transferred from the hydrophobic side to the hydrophilic side, although some water remains on both sides, residing in the hydrophilic channels. A similar type of fabric construction is also described in U.S. Pat. No. 3,250,095 and U.S. Pat. No. 6,806,214. See also US 2006/0148356 and WO 2006/042375.

Another method of weaving or knitting more than one kind of yarn together is shown in U.S. Pat. No. 6,381,994. In this case, the two yarns are synthetic fiber yarns where one yarn has undergone a treatment that creates larger void sizes. These yarns are woven or knitted into a fabric in such a way that causes the treated fibers to be primarily on one side of the fabric and the untreated fibers to be primarily on the other side of the fabric. Moisture transport across the fabric is driven by the difference in void sizes between the types of yarns.

Another example of fabric construction technique consists of a fabric construction wherein the final fabric is made from layers of two different hydrophilic fabrics, as is described in U.S. Pat. No. 6,432,504. One layer (the interior or “skin” side of a garment) is made from coarser fibers, while the second layer is made from finer fibers. Both layers will absorb and wick moisture, but the outer layer made from finer fiber has greater moisture absorbency, due to the smaller fiber size and thus a stronger capillary wicking force. This difference in absorbency drives moisture transfer from the less absorbent (coarser fiber) layer to the more absorbent (finer fiber) layer. This type of construction is commonly referred to as “denier gradient.”

A more complex fabric construction is described in US 2003/0182922 A1. This patent application describes two fabrics that enhance moisture transfer. The fabric construction depends on the use of composite yam that has an inner core of hydrophilic fibers surrounded by an outer sheath of hydrophobic fibers. The first fabric described is made from the composite yarn alone. The second fabric is comprised of two layers of fabric components bound together. The inside fabric component is made from only hydrophobic fibers. The outside fabric component is made from the above-described composite yarn. These two fabric components are joined together to form a fabric such that the fabric component made from only hydrophobic fibers is on the inner face of the fabric and the fabric component made from composite yarn (hydrophilic) is on the outer face of the fabric. Moisture transfer through this two-layered fabric is driven by the difference in hydrophilicity between the inner (hydrophobic) layer and the outer (hydrophilic) layer, but generally requires some extent of wicking channels in the form of hydrophilic yarns or fiber bundles that traverse from outside to the inner side.

The spore-comprising fabric of the present invention may be produced using any finishing process including wet processes such as exhaustion, padding, transfer, spraying, printing, coating, and foam application. Other processes that may be used include microencapsulation, plasma application, sol-gel technology and lamination techniques.

The exhaustion method involves immersion of the fabric in a liquor containing suspended spores. Agitation of the fabric and/or liquid phase leads to deposition of the spore onto the fabric which is subsequently dried.

The padding method involves passing the fabric through the spore-containing liquor in a bath within a short time (typically less than 30 seconds) and squeezing. After the fabric has been padded through the liquor and prior to being squeezed through the rollers of the padder, the liquor is distributed as follows: within the fibers; in the capillary regions-between the fibers; in the spaces between the yams; on the fabric surface.

The transfer method involves a special foulard and the fabric itself is not dipped into the bath. Rather, the liquor containing the spore is taken by a rolling roller and transferred to one side of the fabric. Such finishing systems may be known as ‘Lick/Kiss Roll Applicators.”

Spraying methods may involve conventional nozzle-based spraying of the spore-based liquid onto the fabric followed by a drying step, or indirect spray applicators such as the spinning disc (Farmer Norton) and rotor (Weko) methods.

Printing methods may involve block printing, screen printing, digital printing, direct printing, discharge printing and heat-transfer printing.

Coating methods involve direct addition of a high-viscosity spore-based liquor onto the fabric, for example using a three-roller direct coating system (with metering, application and backup rollers) with level of coating controlled using a doctor blade. Alternatively, a direct transfer coating system may be used involving two rollers and use of heat and pressure to transfer the spore-containing substrate from a coated release paper onto the fabric.

Many foam application-based systems are suitable, involving use one or more surfactants to produce a foam of the spore-containing liquor. Examples of suitable foam application-based methods are the open foam method (Horizontal pad foam, Knife-roll-over foam, Autofoam systems), offset open foam methods (Küsters Janus contact roller system and Monforts vacuum drum system), closed foam methods (FFT Foam Finishing Technology-Gaston County Dyeing Machine, CFS Chemical Foam System-Gaston System, Stork rotary screen foam applicator and Stork CFT Coating and Finishing Technology).

Those skilled person in the art would be able to select a suitable method depending on the specific properties of the fabric and desired durability of the finish. The inventors have found that spore-based finishes with relatively low durability, in terms of washfastness (‘washability’), may be preferred to avoid the spores from being too firmly embedded in the application media and hence prevented from accessing the nutrients required for germination and growth during fabric use. For example, one embodiment of the invention involves spraying, digital printing, padding or exhaustion treatment of a fabric with an aqueous suspension of spores followed by a drying step. This results in lightly adsorbed spores that rapidly germinate on exposure to sufficient nutrients and moisture. However, the spores and any resulting vegetative bacteria are likely to be removed in a subsequent washing step, requiring a reapplication step. In one embodiment, the reapplication step is conducted during the laundering process, for example during the washing, rinsing, or drying step. In another embodiment the reapplication process is conducted using a spray at some stage between the completion of the laundering process and the start of the next laundering process, for example prior to a garment being worn or when the item is deposited in a laundry hamper for storage prior to the next wash cycle.

### Composition

The present disclosure relates to a composition for treating a fabric. As used herein the phrase “fabric treatment compositions” includes compositions designed for treating fabric, including garments, or other textiles.

Such compositions may include but are not limited to, laundry cleaning compositions and detergents, fabric freshening compositions, laundry prewash, laundry pretreat, laundry additives, spray products, laundry rinse additive, wash additive, post-rinse fabric treatment, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the wash and/or rinse cycle of the laundering process.

The composition of the invention is substantially free of fabric conditioning actives Fabric conditioning actives include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. The composition is preferably free of bleach.

The composition may be in any suitable form. It may be in the form of a liquid composition, a granular composition, a single-compartment pouch, a multi-compartment pouch, a sheet, a pastille or bead, a fibrous article, a tablet, a bar, flake, or a mixture thereof. The product can be selected from a liquid, solid, or combination thereof.

The composition may be in liquid form. The composition may include from about 30% to about 90%, or from about 50% to about 80%, by weight of the composition, of water. The pH of the composition is from about 1 to about 6 as measured at 20° C. If the composition is in liquid form the pH is measured neat, if the composition is in solid form the pH is measure in a 1% w/v aqueous solution.

The composition may be a cleaning or additive composition, it may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The composition may be in the form of a pastille or bead. The pastille may include polyethylene glycol as a carrier. The polyethylene glycol may have a weight average molecular weight of from about 2000 to about 20,000 Daltons, preferably from about 5000 to about 15,000 Daltons, more preferably from about 6000 to about 12,000 Daltons.

The composition may comprise a non-aqueous solvent, which may act as a carrier and/or facilitate stability. Non-aqueous solvents may include organic solvents, such as methanol, ethanol, propanol, isopropanol, 1,3-propanediol, 1,2-propanediol, ethylene glycol, glycerine, glycol ethers, hydrocarbons, or mixtures thereof.

### Bacterial Spores

Although bacterial spores can be present on surfaces, the method of the invention involves the intentional addition of bacterial spores to the fabric surface in an amount capable of providing a consumer noticeable benefit, in particular malodor removal and prevention benefit. Preferably, the method of the invention requires the intentional addition of at least 1×10² CFU/g of surface, preferably at least 1×10³ CFU/g of surface, preferably at least 1×10⁴ CFU/g of surface, preferably at least 1×10⁵ CFU/g of surface and preferably less than 1×10¹² CFU/g of surface. By “intentional addition of bacterial spores” is herein meant that the spores are added in addition to the microorganisms that might be present on the surface.

The microbial spores used in the method and composition of the invention can be added to a wash or rinse cycle or sprayed directly onto the fabric. The spores are not deactivated by heat at the temperatures found in a washing machine. The spores are fabric-substantive and provide malodor control during and after the laundry process, in particular during and after the use (e.g. wearing) of the fabrics.

The microbial spores of the method and composition of the invention can germinate on fabrics. The spores can be activated by heat, for example, heat generated during use of the fabric or by the heat provided in the washing machine. The spores can germinate when the fabrics are stored and/or used. Malodor precursors can be used by the bacteria produced by the spores as nutrients promoting germination.

The fabric can be treated in a wet laundry process, or it can be treated wet after being washed, for example by being sprayed. Although the washing process reduces the amount of microorganisms and metabolite on the fabrics further bacteria from the washing machine and washing water can be transferred to the fabrics.

The bacterial spores for use herein: i) are capable of surviving the temperatures found in a laundry process; ii) are fabric substantive; iii) have the ability to control odor; and iv) preferably have the ability to support the cleaning action of laundry detergents. The spores have the ability to germinate and to form cells during the treatment and continue to germinate and form cells on the fabrics using malodor precursors as nutrients. The spores can be delivered in liquid or solid form. Preferably, the spores are in solid form.

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example. Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter, Amphibacillus, Anaerobacillus, Anoxybacillus, Aquibacillus, Aquisalibacillus, Aureibacillus, Bacillus, Caldalkalibacillus, Caldibacillus, Calditerricola, Calidifontibacillus, Camelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudogracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilisstrain NRRL B-50147 (also known as 300R); Bacillus amyloliquefaciens strain NRRL B-50150; Bacillus amyloliquefaciens strain NRRL B-50154; Bacillus megaterium PTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus subtilis (e.g., isolate NRRL B-21661 in RHAPSODY®, SERENADE® MAX and SERENADE® ASO from Bayer CropScience), Bacillus pumilus (e.g., isolate NRRL B-50349 from Bayer Crop Science), Bacillus amyloliquefaciens TrigoCor (also known as “TrigoCor 1448”; e.g., isolate Embrapa Trigo Accession No. 144/88.4Lev, Cornell Accession No.Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof. The bacterial spores may have an average particle diameter of about 0.5 to 50 or from 2 to 50 microns or from 10 to 45 microns or from 0.5-6 microns, suitably about 1-5 microns. Bacillus spores are commercially available in blends in aqueous carriers and are insoluble in the aqueous carriers. Other commercially available bacillus spore blends include without limitation Freshen Free™ CAN (10×), available from Novozymes Biologicals, Inc.; Evogen® Renew Plus (10×), available from Genesis Biosciences, Inc.; and Evogen® GT (10×, 20× and 110×), all available from Genesis Biosciences, Inc. In the foregoing list, the parenthetical notations (10×, 20×, and 110×) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40C-100° C., and held the optimal temperature for not more than 2 hours, preferably between 70-80° C. for 30 min.

For the methods, compositions and products disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed methods, compositions and products are stable (i.e. not undergoing germination), with at least some individual spores in the population capable of germinating.

Populations of bacterial spores used in this disclosure may contain bacterial spores at different concentrations. In various examples, populations of bacterial spores may contain, without limitation, at least 1×10², 5×10², 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, 1×10⁹, 5×10⁹, 1×10¹⁰, 5×10¹⁰, 1×10¹¹, 5×10¹¹, 1×10¹², 5×10¹², 1×10¹³, 5×10¹³, 1×10¹⁴, or 5×10¹⁴ spores/ml, spores/gram, or spores/cm³.

A preferred composition is an aqueous composition having a pH of from about 1 to about 6 as measured at 20° C., preferably the composition comprises from 1 to 20% by weight of the composition of an organic acid, preferably the organic acid is selected from the group consisting of acetic acid, citric acid, lactic acid and mixtures thereof. Preferably, the composition comprises a polymer. Preferably, the composition comprises a soil release polymer.
Preferably the composition comprises:
   (a) an organic acid, preferably selected from the group consisting of acetic acid, citric acid, lactic acid and mixtures thereof;
   (b) from about 1% to about 25%, by weight of the composition, of a first polymer, the first polymer being a soil release polymer (SRP); and
   (c) optionally from about 1% to about 25%, by weight of the composition, of a second polymer, preferably, the second polymer being a graft copolymer, an alkoxylated polyalkyleneimine polymer, or a mixture thereof,
      wherein the graft copolymer, if present, comprises
      i) water-soluble polyalkylene oxides as a graft base, and
      ii) one or more side chains formed by polymerization of a vinyl ester component.

The composition may comprise first polymer (a) which is a soil release polymer (such as a terphthalate-derived soil release polymer), and second polymer (b) selected from a PEG/vinyl acetate graft copolymer, an alkoxylated polyalkyleneimine polymer, or mixtures thereof. Polymers (a) and (b) may form a polymer system. The polymer system may include additional polymers, preferably polymers that provide a benefit to fabrics. As shown by the examples below, fabric treatment compositions that include polymers (a) and (b) in combination provide superior wicking benefits to fabrics when compared to compositions that comprise only polymer (a) or polymer (b).

Suitable cleaning ingredients include at least one of a surfactant, although preferably the composition is substantially free of surfactant, an enzyme, an enzyme stabilizing system, a detergent builder, a chelating agent, a complexing agent, clay soil removal/anti-redeposition agents, polymeric soil release agents, polymeric dispersing agents, polymeric grease cleaning agents, a dye transfer inhibiting agent, a foam booster, an anti-foam, a suds suppressor, an anti-corrosion agent, a soil-suspending agent, a dye, a hueing dye, a tarnish inhibitor, an optical brightener, a perfume, a saturated or unsaturated fatty acid, a calcium cation, a magnesium cation, a visual signaling ingredient, a structurant, a thickener, an anti-caking agent, a starch, sand, a gelling agents, or any combination thereof.

Surfactant System: The composition may comprise a surfactant system in an amount sufficient to provide desired cleaning properties. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material. Preferably the composition is substantially free of anionic surfactant. Preferably the composition is substantially free of cationic surfactant.

Enzymes. Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, and amylases, or mixtures thereof. A typical combination is an enzyme cocktail that may comprise, for example, a protease and lipase in conjunction with amylase.

Enzyme Stabilizing System. The composition may optionally comprise from about 0.001% to about 10% by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Builder. The composition may optionally comprise a builder or a builder system. Built cleaning compositions typically comprise at least about 1% builder, based on the total weight of the composition. Liquid cleaning compositions may comprise up to about 10% builder, and in some examples up to about 8% builder, of the total weight of the composition. Granular cleaning compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing cleaning compositions. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Also suitable for use as builders herein are synthesized crystalline ion exchange materials or hydrates thereof having chain structure and a composition represented by the following general anhydride form: x(M₂O).ySiO₂.zM′O wherein M is Na and/or K, M′ is Ca and/or Mg; y/x is 0.5 to 2.0; and z/x is 0.005 to 1.0.

Alternatively, the composition may be substantially free of builder.

Chelating Agent. The composition may also comprise one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins, and mixtures therein. Chelating agents can be present in the acid or salt form including alkali metal, ammonium, and substituted ammonium salts thereof, and mixtures thereof.

Dye Transfer Inhibiting Agent. The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof.

Preferably the composition is substantially free of bleaching compounds.

Brightener. Optical brighteners or other brightening or whitening agents may be incorporated at levels of from about 0.01% to about 1.2%, by weight of the composition.

Commercial brighteners, which may be used herein, can be classified into subgroups, which include, but are not necessarily limited to, derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

In some examples, the fluorescent brightener is selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by Ciba Geigy Corporation), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, monoethanolamine, propane diol.

Fabric Hueing Agent. The composition may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Encapsulate. The composition may comprise an encapsulate. The encapsulate may comprises a core, a shell having an inner and outer surface, where the shell encapsulates the core.

In certain aspects, the encapsulate comprises a core and a shell, where the core comprises a material selected from perfumes; brighteners; dyes; insect repellants; silicones; waxes; flavors; vitamins; fabric softening agents; skin care agents, e.g., paraffins; enzymes; anti-bacterial agents; bleaches; sensates; or mixtures thereof; and where the shell comprises a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts, or mixtures thereof. In some aspects, where the shell comprises an aminoplast, the aminoplast comprises polyurea, polyurethane, and/or polyureaurethane. The polyurea may comprise polyoxymethyleneurea and/or melamine formaldehyde.

Other ingredients. The composition can further comprise silicates. Suitable silicates can include, for example, sodium silicates, sodium disilicate, sodium metasilicate, crystalline phyllosilicates or a combination thereof. In some embodiments, silicates can be present at a level of from about 1% to about 20% by weight, based on the total weight of the composition.

The composition can further comprise other conventional detergent ingredients such as foam boosters, suds suppressors, anti-corrosion agents, soil-suspending agents, anti-soil redeposition agents, dyes, bactericides, tarnish inhibiters, optical brighteners, or perfumes.

The composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic cellulose, cationic starch, cationic polyacylamides or a combination thereof. If present, the fatty acids and/or the deposition aids can each be present at 0.1% to 10% by weight, based on the total weight of the composition.

The composition may optionally include silicone or fatty-acid based suds suppressors; hueing dyes, calcium and magnesium cations, visual signaling ingredients, anti-foam (0.001% to about 4.0% by weight, based on the total weight of the composition), and/or a structurant/thickener (0.01% to 5% by weight, based on the total weight of the composition) selected from the group consisting of diglycerides and triglycerides, ethylene glycol distearate, microcrystalline cellulose, microfiber cellulose, biopolymers, xanthan gum, gellan gum, and mixtures thereof).

### Additive Composition

The additive compositions of the present disclosure may include additional adjunct ingredients. Such adjuncts may provide additional treatment benefits to the target fabrics, and/or they may act as stabilization or processing aids to the compositions. Suitable adjuncts may include chelant, perfume, structurant, chlorine scavenger, malodor reduction materials, organic solvents, or mixtures thereof.

### Test Method 1

The following test method can be used to determine the vertical wicking performance of a textile. The set of nine textiles listed in Table 1 is used to illustrate the method. Textiles 1-8 were purchased from BTC Activewear, Wednesbury, United Kingdom. Textile 9 was produced by Nike (UK) Ltd., Sunderland, United Kingdom.

TABLE 1
Fabric set

| Fabric | Brand | Ref | Composition* |
|---|---|---|---|
| 1 | Fruit of the | 61082 Fruit of the Loom | 100% Cotton |
| | Loom ® | Men’s Original T-shirt | |
| 2 | Gildan ® | 46000 Performance Adult | 100% Polyester |
| | | Core T-Shirt | |
| 3 | Gildan ® | 64000 Softstyle Adult T-Shirt | 100% Cotton |
| 4 | Bella | CA3650 Unisex Polycotton | 52% Cotton |
| | Canvas ® | Short sleeve T-Shirt | 48% Polyester |
| 5 | B&C ® | TU01T Men’s #E150 T-Shirt | 100% Cotton |
| 6 | Fruit of the | 61390 Men’s Performance | 100% Polyester |
| | Loom ® | T-shirt | |
| 7 | Kustom | KK504 Superwash 60° | 65% Polyester |
| | Kit ® | T-Shirt Fashion Fit | 35% Cotton |
| 8 | TeeJays ® | TJ7020 Men’s Cooldry | 95% Polyester |
| | | T-Shirt | 5% Spandex |
| 9 | Nike ® | BV6883-302 Park 20 DriFit | 100% Polyester |
| | | T-Shirt | |

*As declared by the manufacturer

### Wicking Method Protocol (Test Method 1)

Fabric swatches were cut into 18 cm×2.5 cm strips using a Laser cutter (HPC Laser LS6090, Laserscript). For each fabric, four swatches were cut with the long dimension in the vertical wale (loops on top) direction and four other swatches were cut with the long dimension in the horizontal course (loops on side) direction. The strips were washed twice (60° C. Short Cotton wash, duration 1 hour 25 minutes, Miele W3922, using soft water with hardness <2 US grains per gallon) with 15 g of ECE-2 (batch ECE2.181-377, WFK Testgewebe Gmbh) in a mesh bag and then rinse twice with the same cycle. The strips were dried in an electrical dryer (Minimum iron program, hand iron, Miele Novotronic T430) and then ironed using cotton fabric between the iron and the strip. The fabric strips were equilibrated by storing the samples at 21.1° C. (70° F.) and 50% Relative Humidity at least 24 hours. A mark was drawn at 0.5 cm and 10.5 cm from the bottom of each strips.

To determine the wicking distance, 2 L of distilled water and 0.50 mL of a dye (Liquitint Pink AMC, Miliken) were added to a 2 L plastic bottle. The mixture was stirred until homogenous. The solution was poured into a flat plastic tray which was placed on top of an adjustable stage. Fabric strips were clamped to a line, then the stage was raised up so that the fabrics became submerged up to the 0.5 cm mark. The timer was started as soon as the dyed water reached the 0.5 cm mark.

The time was recorded for the solution to travel 10 cm fabric or the distance was recorded after 15 mins, whichever occurs first. For each fabric, the test was run for 4 vertical strips and 4 horizontal strips. Wicking distance was reported as the average distance travelled by the water for the 15 minutes time interval. If 10 cm was reached before the end of the 15-minute interval, the distance was recorded as >10 cm and the time was recorded.

Results for textiles 1-9 are shown in Table 2.

TABLE 2
Vertical wicking

| | | Wicking | Time to travel |
|---|---|---|---|
| Textile | Composition | distance (cm) | 10 cm (s) |
| 1 | 100% Cotton | 8.42 | >900 |
| 2 | 100% Polyester | >10 | 495 |
| 3 | 100% Cotton | 6.74 | >900 |
| 4 | 52% Cotton | >10 | 287 |
| | 48% Polyester | | |
| 5 | 100% Cotton | >10 | 548 |
| 6 | 100% Polyester | 2.09 | >900 |
| 7 | 65% Polyester | >10 | 354 |
| | 35% Cotton | | |
| 8 | 95% Polyester | 0.00 | >900 |
| | 5% Spandex | | |
| 9 | 100% Polyester | 7.01 | >900 |

### EXAMPLE 1

The set of 9 fabric described in Table 1 was used in this test. Fabrics were cut into 5×5 cm swatches and washed twice (60° C. Cotton Short cycle, 1h25, soft water, Miele W3922) with 15 g of ECE-2 detergent (batch ECE2.181-377, wfk Testgewebe GmbH) in a mesh bag and then washed a further two cycles without detergent using the same appliance and conditions. The swatches were then sterilized prior to testing using a Phoenix autoclave (Rodwell Autoclave Company).

Swatches were placed in individual sterile Petri dishes using sterile tweezers and 200 μL of a 5.24 ×10⁶ cfu/mL Bacillus Spores blend (Evozyme® P500 BS7, Genesis Biosciences Ltd) was pipetted on the inner side (skin contact surface) of each swatch. Petri dishes were left to dry in an oven at 35° C. for 72 h. 7 mL of 50% tryptic soy broth (product code: 22092, Sigma Aldrich) solution was poured in 50 mL centrifuge tube (product code: E1450-0400, Star Lab). Swatches were put in individual centrifuge tubes and shaken at 35° C. and 400 rpm for 24 hours.

Triphenyl tetrazolium chloride (TTC) is a transparent compound that is reduced to a red formazan dye when metabolized by bacteria. TTC was used as a method for detecting the growth and germination of Bacillus spores on different type of fabric. To evaluate the impact of fabric, centrifuge tubes were vortexed for 10 seconds and 1.4 mL of each tube was transferred to an Eppendorf tube (product code: E0030123328, Eppendorf). 100 μL of TTC solution (product code: 102332880, Sigma Aldrich) was added in each Eppendorf tube and incubated for 20 mins at 37° C. and 400 rpm. Tubes were then centrifuged at 4000 rpm for 3 min, followed by decantation of the supernatant.1.4 mL of supernatants was pipetted out and the pellets obtained were resuspended in 10 ml of a 50% ethanol solution. The absorbance of the red formazan solution obtained at the end was measured by spectrophotometer (Libra S22, Biochrom Ltd) at 480 nm using a 10 mm path length cuvette (Kartell SpA, product code 1938, 1.5 ml capacity).

The test was run in triplicate for each fabric, including a negative control (tryptic soy broth without fabric). Table 3 shows that the high-synthetic textiles with high wicking properties show the highest production of red formazan, indicating highest levels of Bacillus spore germination and growth. Fabrics 9 and 2, which have both high synthetic content (100%) and high wicking properties, show significantly higher red formazan generation than all the other fabrics which either have lower synthetic content or lower wicking properties.

TABLE 3
Assessment of fabric impact on Bacillus
spores using TTC.

| | | | | | Significantly |
|---|---|---|---|---|---|
| | | | Absorb- | Absorb- | different with |
| | | Wicking | ance | ance | the fabric |
| Fab- | Compo- | distance | average | standard | (Student’s t-test, |
| ric | sition | (cm) | (480 nm) | deviation | p < 0.05) |
| 9 | 100% | 7.01 | 0.92 | 0.09 | 1, 3, 4, 5, 6, 7, 8 |
| | Polyester | | | | |
| 2 | 100% | >10 | 0.91 | 0.08 | 1, 3, 4, 5, 6, 7, 8 |
| | Polyester | | | | |
| 6 | 100% | 2.09 | 0.75 | 0.05 | 2, 9 |
| | Polyester | | | | |
| 4 | 52% | >10 | 0.63 | 0.11 | 2, 9 |
| | Cotton | | | | |
| | 48% | | | | |
| | Polyester | | | | |
| 7 | 65% | >10 | 0.62 | 0.14 | 2, 9 |
| | Polyester | | | | |
| | 35% | | | | |
| | Cotton | | | | |
| 3 | 100% | 6.74 | 0.61 | 0.09 | 2, 9 |
| | Cotton | | | | |
| 8 | 95% | 0.00 | 0.57 | 0.13 | 2, 9 |
| | Polyester | | | | |
| | 5% | | | | |
| | Spandex | | | | |
| 1 | 100% | 8.42 | 0.57 | 0.10 | 2, 9 |
| | Cotton | | | | |
| 5 | 100% | >10 | 0.52 | 0.15 | 2, 9 |
| | Cotton | | | | |

### EXAMPLES 2-3

The compositions in the tables below exemplify rinse additives designed for treatment of textiles.

### EXAMPLE 2

| | Composition 1 | Composition 2 |
|---|---|---|
| | (Inventive) | (Comparative) |
| Ingredients | wt.-% | wt.-% |
| Polymer (a)¹ | 10.10 | 10.10 |
| Polymer (b)² | 10.10 | 10.10 |
| Solvent³ | 2.60 | 2.60 |
| Perfume Oil | 1.30 | 1.30 |
| Surfactant⁴ | 1.00 | 1.00 |
| Chelant | 3.79 | 3.79 |
| Chlorine Scavenger | 1.18 | 1.18 |
| Encapsulated Perfume⁵ | 0.13 | 0.13 |
| Malodor reduction | 0.05 | 0.05 |
| materials (encapsulated) | | |
| Acidulant | 0.05 | 0.05 |
| Preservative | 0.00 | 0.00 |
| Structurant mix | 4.00 | 4.00 |
| Bacillus spore⁶ | 0.01 | — |
| DI Water | q.s. to 100 | q.s. to 100 |
| Total polymer (a + b) | 20.20 | 20.20 |
| Polymer wt. ratio (a:b) | 1:1 | 1:1 |

¹Polymer (a): nonionic SRP (e.g., Texcare ® SNR240 or SNR260
²Polymer (b): PEG/polyvinyl acetate graft copolymer (e.g., with the weight ratio of PEG:polyvinyl acetate of about 40:60)
³Solvent: e.g., glycerol, propylene glycol
⁴Surfactant: nonionic surfactant (ethoxylated alcohol)
⁵Encapsulated perfume: core-in-shell encapsulate, including melamine-formaldehyde wall material and a polyvinyl formamide coating (as deposition aid) on the wall
⁶Bacillus spore: Evozyme ® P500 BS7, Genesis Biosciences, Cardiff

### EXAMPLE 3

### Acid Rinse (Nil Surfactant)

| | Composition 1 | Composition 2 |
|---|---|---|
| | (Inventive) | (Comparative) |
| Ingredients | wt.-% | wt.-% |
| Citric Acid | 23.70% | 23.70% |
| Vinegar (6% acetic acid) | 2.60% | 2.60% |
| Bacillus spore | 0.01% | — |
| Sodium Hydroxide | 2.00% | 2.00% |
| 1,2 propanediol | 5.00% | 5.00% |
| Perfume | 0%-1.0% | 0%-1.0% |
| DI Water | q.s. to 100 | q.s. to 100 |

Properties

| | | |
|---|---|---|
| Neat pH | 2.72 | 2.50 |
| Viscosity (cp) @60 | Less than 10 cp | Less than 10 cp |
| RPM, 22° C.) | | |

Bacillus spores: Evozyme ® P500 BS7, Genesis Biosciences, Cardiff

### EXAMPLE 4

Preparation of Fabric Loaded with Spores
A stock suspension of 4×10⁸ CFU Bacillus spores (Evozyme® P500 BS7, Genesis Biosciences, Cardiff) in 100 ml deionized water was produced. This was sprayed onto each side of a sweat-wicking athletic shirt (Nike Dri-Fit Park 20 Football Jersey, Size 2XL, Green) with a 1 L Hozelock Spraymist translucent trigger sprayer using a level of 20 ml per m² on both the outside and inner (skin contact) surfaces of the garment. The item was then line dried, resulting in a finished garment with 8×10⁷ spores per square meter on both its outer and inner surfaces.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of depositing bacterial spores on a moisture-wicking synthetic fabric, comprising the step of contacting the fabric with an aqueous liquor comprising from about 1×10² to about 1×10⁸ CFU/l of the aqueous liquor, of bacterial spores wherein the aqueous liquor is substantially free of fabric conditioning agent.

2. The method according to claim 1 wherein the fabric comprises at least 70%, by weight of the fabric, of synthetic fibers.

3. The method according to claim 1 wherein the fabric is knitted and comprises at least 70% by weight of the fabric of polyester.

4. The method according to claim 1 wherein the fabric is knitted and comprises at least 95% by weight of the fabric of polyester.

5. The method according to claim 1 wherein the fabric has a wicking distance of greater than 3 cm based on Test Method 1.

6. The method according to claim 1 wherein the fabric is warp-knitted and comprises:
(a) an inner surface intended for skin contact comprising polyester yarns of between about 30 to about 140 denier, wherein the yarns comprise fibers of between about 1 to about 3 denier; and
(b) an outer surface opposed to the inner surface, the outer surface comprising polyester yarns of between about 30 to about 140 denier, wherein the yarns comprise fibers of between about 0.2 to about 0.9 denier.

7. The method according to claim 6 wherein the outer surface comprises polyester yarns of between about 50 to about 90 denier, and fibers of between about 1 to about 2.5 denier and the inner surface comprises polyester yarns of between about 50 to about 90 denier, and fibers of between about 0.3 to about 0.8 denier.

8. The method according to claim 1 further comprising preloading the fabric with bacterial spores before contacting the fabric with the aqueous liquor.

9. The method according to claim 1 wherein the bacterial spores comprise Bacillus spores, comprising Bacillus subtilis, Bacillus amyloliquefaciens, Bacillus licheniformis, Bacillus megaterium, Bacillus pumilus, Bacillus cereus, Bacillus thuringiensis, Bacillus mycoides, Bacillus tequilensis, Bacillus vallismortis, Bacillus mojavensis, or a combination thereof.

10. The method according to claim 1 wherein the bacterial spores comprise Bacillus spores wherein the Bacillus are selected from the group consisting of Bacillus subtilis, Bacillus amyloliquefaciens, Bacillus licheniformis, Bacillus megaterium, Bacillus pumilus, and mixtures thereof.

11. The method according to claim 1 wherein contacting the fabric with the aqueous liquor comprises spraying the aqueous liquor onto the fabric.

12. The method according to claim 1 wherein the method takes places in a washing machine, or in a hand washing process.

13. The method according to claim 1 wherein the method takes places in the rinse cycle a washing machine, or in a hand washing process.

14. A composition for use in the method of claim 1 wherein the composition comprises from about 1×10² CFU/g to about 1×10⁹ CFU/g of the composition of bacterial spores and wherein the composition has a pH of from about 1 to about 6 as measured at 20° C. and it is substantially free of fabric conditioning agent and substantially free of bleach.

15. The composition according to claim 14 further comprising
(a) an organic acid; and
(b) a polymer.

16. The composition according to claim 14 further comprising:
(a) from about 1 to about 20% by weight of the composition of an organic acid;
(b) from about 1% to about 25%, by weight of the composition, of a first polymer, the first polymer being a soil release polymer; and
(c) from about 1% to about 25%, by weight of the composition, of a second polymer, the second polymer being a graft copolymer, an alkoxylated polyalkyleneimine polymer, or a mixture thereof,
wherein the graft copolymer, if present, comprises
i) water-soluble polyalkylene oxides as a graft base, and
ii) one or more side chains formed by polymerization of a vinyl ester component.

17. A moisture-wicking synthetic fabric comprising at least 1×10² CFU per gram of fabric of bacterial spores.
